(19) United States
(12) Patent Application Publication
(10) Pub. No.: US 2026/0286170 A1
(43) Pub. Date: Sep. 24, 2026

(54) HYBRID EPOXY-POLYURETHANE WATERBORNE PRIMER, METHODS FOR ITS PREPARATION AND METHODS FOR USING

(71) Applicant: SWIMC LLC, Cleveland, OH (US)

(72) Inventors: Liang LIANG, Twinsburg, OH (US); Peter MAASSEN VAN DEN BRINK, Amsterdam (NL); Aidin RASHIDI, Beachwood, OH (US); Zhangqing YU, Twinsburg, OH (US)

(21) Appl. No.: 19/475,459

(22) PCT Filed: Apr. 11, 2024
(86) PCT No.: PCT/US2024/023997

§ 371 Date: Oct. 15, 2025

Related U.S. Application Data
(60) Provisional application No. 63/460,152, filed on Apr. 18, 2023.

(51) Int. Cl. C09D 163/10; C09D 5/00; C09D 7/63; C09D 7/65; C09D 7/80

(52) U.S. Cl. CPC C09D 163/10; C09D 5/002; C09D 7/63; C09D 7/65; C09D 7/80

(57) ABSTRACT

Hybrid waterborne primer compositions are provided, particularly hybrid epoxy-polyurethane waterborne primers, along with methods for their production and their use.

### CROSS-REFERENCE TO RELATED APPLICATIONS

The present application is related to, and claims priority to, U.S. Provisional Application Ser. No. 63/460,152, filed Apr. 18, 2023, pending, the entire contents of which are incorporated herein by reference.

### TECHNICAL FIELD

The present invention relates to hybrid epoxy-polyurethane waterborne primer compositions, methods for their production and methods for using them, particularly as a primer on substrates containing metal surfaces.

### BACKGROUND OF THE INVENTION

There is an increasing demand for the development and use of waterborne coatings due to environmental considerations, especially the negative impacts on environment resulting from solvent-borne coating solutions, and particularly the volatile organic compounds (VOC) associated therewith. Solvent borne primers are frequently used in the refinishing of vehicles, which provide improved performance in areas such as anticorrosion. However, the VOC associated with solvent-borne primers is one of the critical issues prompting interest in a switch to waterborne primers.

Low VOC and zero emission are significant advantages of waterborne coatings, providing a motivation to develop various waterborne coating solutions. Many efforts had been addressed to replace solvent-borne primers with waterborne primers. However, past efforts have resulted in poor performance, particularly in the area of anticorrosion, thus restricting the use of waterborne primers, especially for refinishing vehicles and for coating other metal surfaces in particular.

A primer is a paint or coating product that allows finishing paint to adhere to a surface much better than if it were used alone. It is designed to adhere to surfaces and to form a binding layer that is better prepared to receive the paint. Compared to paint, a primer is not typically intended to be used as the outermost durable finish and can instead be engineered to have improved filling and binding properties with the material underneath. Sometimes this can be achieved by chemistry, and others by controlling the primer's physical properties such as its porosity, tackiness, and hygroscopy.

### SUMMARY OF THE INVENTION

Accordingly one object of the present invention is to provide hybrid waterborne primer compositions that have a combination of properties not otherwise attainable with a single polymer based primer.

A further object of the present invention is to provide hybrid waterborne primer compositions that can be applied to substrates, particularly metal substrates, without the need for use of an etch primer.

A further object of the present invention is to provide hybrid waterborne primer compositions that can be applied to substrates, particularly metal substrates, after initial application of an etch primer, with the hybrid waterborne primer composition providing comparable or improved adhesion, anticorrosion, and anti-hydrolysis properties, among other properties when compared to conventional solvent borne primers used with etch primers.

Another object of the present invention is to provide methods for the production of the hybrid waterborne primer compositions of the present invention, and methods for their use.

These and other objects of this invention, alone or in combination, have been satisfied by the discovery of a hybrid primer comprising a crosslinked polymer network formed from an epoxy resin, a polyurethane dispersion, and an isocyanate containing compound;
methods for its production and for its application in substrate coating, particularly metal substrate coating.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 provides a schematic representation of the reaction used to prepare an exemplary embodiment of the hybrid epoxy-polyurethane waterborne primer of the present invention.

FIG. 2 provides a schematic illustration of the structure of certain embodiments of the hybrid epoxy-polyurethane waterborne primer of the present invention.

FIG. 3A provides a photographic representation of anticorrosion performance after 20 days of salt spray testing between substrates coated with a conventional polyurethane solvent borne primer control [(a) and (b)] compared to a hybrid epoxy-polyurethane waterborne primer of certain embodiments of the present invention [(c) and (d)].

FIG. 3B provides a graphical representation of anticorrosion performance from the photographs of FIG. 3A with the darker box values being the control (a) and the lighter box values being embodiments of the present invention (b).

FIG. 4A is a further photographic representation of anticorrosion performance after 20 days of salt spray testing between substrates coated with a conventional polyurethane solvent borne primer control [(a) and (b)] compared to a hybrid epoxy-polyurethane waterborne primer of certain embodiments of the present invention [(c), (d), (e), and (f)].

FIG. 4B provides a graphical representation of anticorrosion performance from the photographs of FIG. 4A, comparing the conventional 2K polyurethane solvent borne primer control (a), a hybrid epoxy-polyurethane primer of the present invention containing 30% epoxy (b), and a hybrid epoxy-polyurethane primer of the present invention containing 50% epoxy (c).

### DETAILED DESCRIPTION OF THE INVENTION

The present invention relates to hybrid epoxy-polyurethane waterborne primers, methods used to prepare the primers and their use as coatings on substrates, particularly metal substrates. The hybrid epoxy-polyurethane waterborne primers of the invention can be used alone as a direct-to-substrate (or in certain embodiments, direct-to-metal or “DTM”) primer, or in combination with a surface treatment on the substrate to be coated, such as an etching primer or other chemical surface treatment to render the surface of the substrate better able to receive and bond with the hybrid epoxy-polyurethane waterborne primer of the invention.

Within the context of the present invention, the term “hybrid primer” includes, but is not limited to, semi- and fully interpenetrating crosslinked networks of two polymer types, blends of two different polymer types that have been chemically bonded either directly or via a linking agent, chemically bonded crosslinked networks of two polymer types, a crosslinked network of one polymer type chemically modified by a compound that then can form its own crosslinked network after bonding to the original crosslinked network, and the like.

Within the context of the present invention, the term “waterborne” is intended to mean that the polymeric components are in an aqueous medium and VOC is less than 250 g/L. In certain embodiments, waterborne coatings provide one or more of the following advantages:
Low toxicity and flammability due to low VOC levels and low HAP emissions
Lower cost than solvent-borne coatings and no additives, thinners, or hardeners are required in most cases
Less coating is required to cover the same surface area as compared to the use of solvent borne coating solutions.
Paint guns can be readily cleaned with water or water-based solutions and do not require paint thinner, acetone, or methyl acetate (further environmentally friendly and user safety friendly).
Plus drying time of waterborne primer is less than that of solvent borne primer and drying time for sanding is close to that of solvent borne primer
There is no special requirement for storage of waterborne primer based on safety considerations and for discharge of waste waterborne primer

The term “comprises” and variations thereof do not have a limiting meaning where these terms appear in the description and claims.

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

The term “dispersion” in the context of the present invention refers to the mixture of a dispersible polymer and a carrier. The term “dispersion” includes, but is not limited to, the term “solution.”

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

Epoxy resins are well known as high-performance materials in various construction and metal coating applications, providing the combined properties of chemical resistance, adhesion, corrosion resistance, mechanical strength, and high flexibility in some cases. On the other hand, polyurethanes have been shown to have rapid reaction with isocyanate in a short time and improved coating performance properties such as a wide range of hardness, abrasion and impact resistance, flexibility, and strong bonding properties. Both epoxy and polyurethane waterborne primers are commercially available for use in the area of refinishing vehicles. However, individual epoxy waterborne primers exhibit some weakness since a long drying time is not desirable in a rapid coating process and the epoxy primer sanding capability is not as good as that of a polyurethane primer. The sanding capability of rigid epoxy resin is a detriment, since it is difficult to attain a smooth surface with higher optical appearance, especially when cured at room temperature. Longer drying times due to slow reaction rate between the epoxy and an amine curing agent is another significant detriment since most customers are looking fast dry of process.

Polyurethane (PU) dispersions are PU resins dispersed in water which can produce a unique combination of toughness, mechanical properties and durability typically not achievable in other polymer chemistries. These resins are used on a wide range of surfaces and applications, including wood, metal, plastics, masonry and textiles. Meanwhile, water-based polyurethanes dispersion for manufacture of adhesive has excellent performance on heat resistant, fast drying, endurance bonding strength and atomization. Although waterborne polyurethanes demonstrate many property advantages, the pore structure inside the coating layer generated by the reaction of isocyanate with water can diminish the stability of the coating formed from polyurethanes. Additionally, the adhesive strength of polyurethane primers with steel is poor, thus requiring the use of an etch primer first on the substrate, adding a step in the coating process and resulting in an increase of process and raw materials costs.

Accordingly, a primer is needed that can combine the chemical resistance, adhesion, corrosion resistance, mechanical strength and high flexibility of epoxy primers with the short drying time, hardness, abrasion and impact resistance and bonding properties of polyurethane primers.

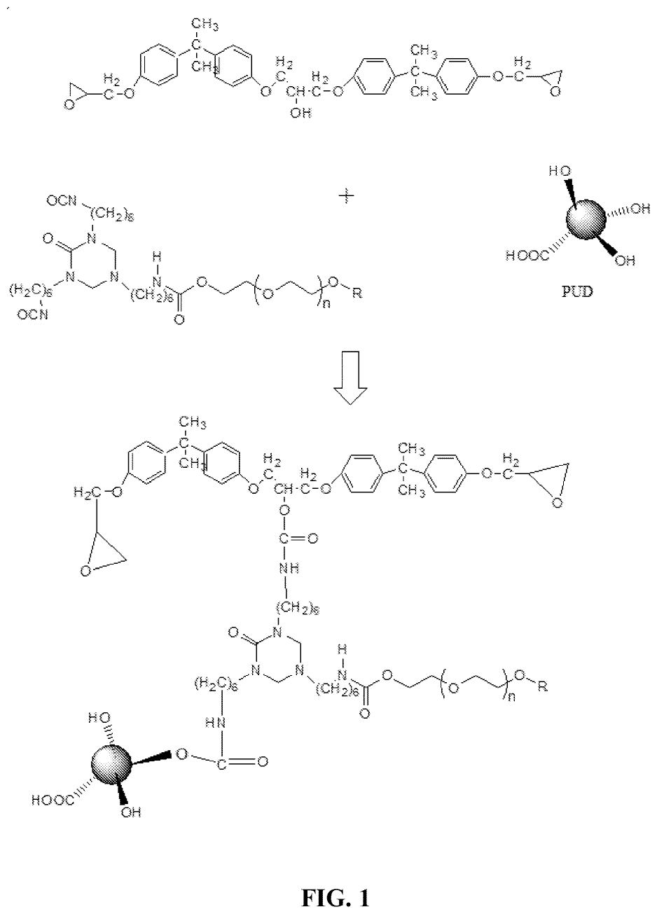

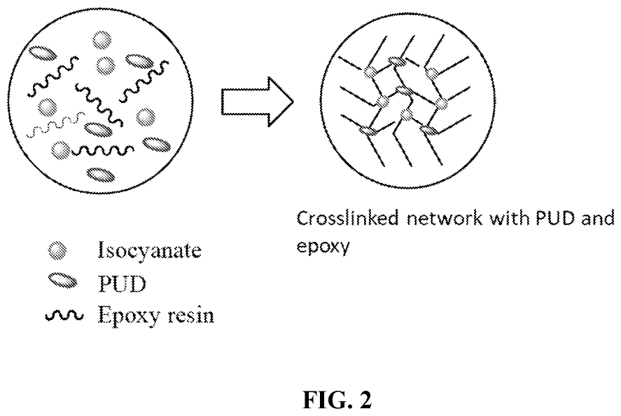

Thus, one embodiment of the present invention provides a hybrid epoxy-polyurethane waterborne primer providing this desired combination of properties. The hybrid epoxy-polyurethane waterborne primer of embodiments of the present invention is obtained by blending an epoxy resin and a polyurethane waterborne dispersion together with an isocyanate compound. The reactions between the polyurethane dispersion and isocyanate, and the epoxy resin and isocyanate generate two crosslinked networks as shown in FIGS. 1 and 2, separately. These two crosslinked networks can be crosslinked with one another by the isocyanate as curing agent, by which the adhesive and mechanical strength of film can be dramatically improved. The hybrid epoxy-polyurethane waterborne primer of embodiments of the present invention provides one or more of the following advantages:
Reduced drying time by fast reaction of polyurethane dispersion and isocyanate
Improved flexibility of epoxy resin by flexible polyurethane
Increased chemical and thermal stability by epoxy resin
No etch primer is required (although one can be used if desired)
Improved sanding capability of film developed by epoxy primer
Better anti-corrosion performances of film

Accordingly, in certain embodiments of the present invention, a hybrid primer is provided comprising a crosslinked polymer network formed from an epoxy resin, a polyurethane dispersion, and an isocyanate containing compound.

The epoxy resin includes, but is not limited to, epoxies formed from epichlorohydrin and one or more bisphenol compounds. The one or more bisphenol compounds can be any suitable bisphenol compound, and can be selected based on the end properties desired from the epoxy resin portion of the hybrid primer.

In certain embodiments, the bisphenol compound includes but is not limited to one or more compounds selected from the following:

| Structural formula | Name | CAS |
|---|---|---|
| 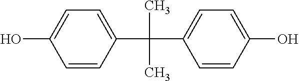 [SMILES: CC(C)(c1ccc(O)cc1)c1ccc(O)cc1] | Bisphenol A | 80-05-7 |
| 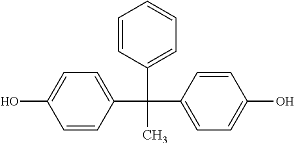 [SMILES: CC(c1ccccc1)(c1ccc(O)cc1)c1ccc(O)cc1] | Bisphenol AP | 1571-75-1 |
| 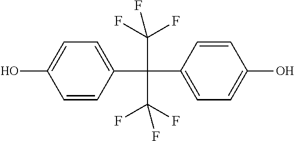 [SMILES: Oc1ccc(C(c2ccc(O)cc2)(C(F)(F)F)C(F)(F)F)cc1] | Bisphenol AF | 1478-61-1 |
| 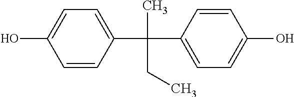 [SMILES: CCC(C)(c1ccc(O)cc1)c1ccc(O)cc1] | Bisphenol B | 77-40-7 |
| 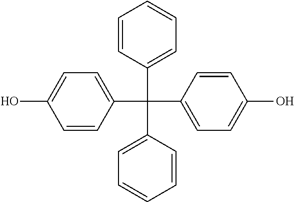 [SMILES: Oc1ccc(C(c2ccccc2)(c2ccccc2)c2ccc(O)cc2)cc1] | Bisphenol BP | 1844-01-5 |
| 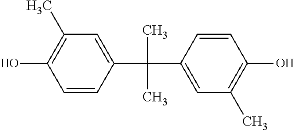 [SMILES: Cc1cc(C(C)(C)c2ccc(O)c(C)c2)ccc1O] | Bisphenol C | 79-97-0 |
| 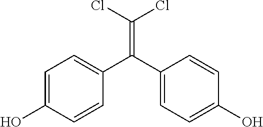 [SMILES: Oc1ccc(C(=C(Cl)Cl)c2ccc(O)cc2)cc1] | Bisphenol C 2 | 14868-03-2 |
| 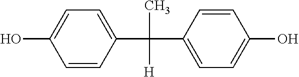 [SMILES: CC(c1ccc(O)cc1)c1ccc(O)cc1] | Bisphenol E | 2081-08-5 |
| 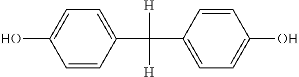 [SMILES: Oc1ccc(Cc2ccc(O)cc2)cc1] | Bisphenol F | 620-92-8 |
| 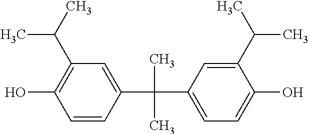 [SMILES: CC(C)c1cc(C(C)(C)c2ccc(O)c(C(C)C)c2)ccc1O] | Bisphenol G | 127-54-8 |
| 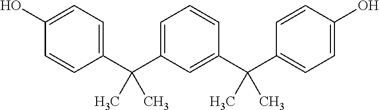 [SMILES: CC(C)(c1ccc(O)cc1)c1cccc(C(C)(C)c2ccc(O)cc2)c1] | Bisphenol M | 13595-25-0 |
| 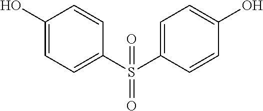 [SMILES: O=S(=O)(c1ccc(O)cc1)c1ccc(O)cc1] | Bisphenol S | 80-09-1 |
| 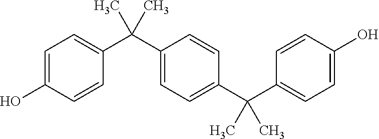 [SMILES: CC(C)(c1ccc(O)cc1)c1ccc(C(C)(C)c2ccc(O)cc2)cc1] | Bisphenol P | 2167-51-3 |
| 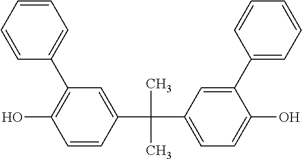 [SMILES: CC(C)(c1ccc(O)c(-c2ccccc2)c1)c1ccc(O)c(-c2ccccc2)c1] | Bisphenol PH | 24038-68-4 |
| 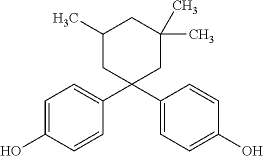 [SMILES: CC1CC(C)(C)CC(c2ccc(O)cc2)(c2ccc(O)cc2)C1] | Bisphenol TMC | 129188-99-4 |
| 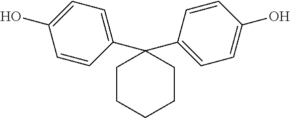 [SMILES: Oc1ccc(C2(c3ccc(O)cc3)CCCCC2)cc1] | Bisphenol Z | 843-55-0 |
| 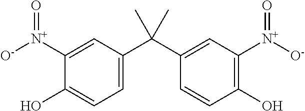 [SMILES: CC(C)(c1ccc(O)c([N+](=O)[O-])c1)c1ccc(O)c([N+](=O)[O-])c1] | Dinitrobisphenol A | 5329-21-5 |
| 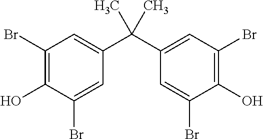 [SMILES: CC(C)(c1cc(Br)c(O)c(Br)c1)c1cc(Br)c(O)c(Br)c1] | Tetrabromobisphenol A | 79-94-7 |

Preferably, the one or more bisphenol compounds are selected from the group consisting of bisphenol A, bisphenol B, bisphenol E, bisphenol F, and bisphenol AF.

Curing (or crosslinking) of the epoxy resin may be achieved by reacting an epoxy with itself (homopolymerisation) or by forming a copolymer with polyfunctional curatives or hardeners. This curing is what produces the qualities of the substance such as resistance, durability, versatility, and adhesion. Any desired molecule containing a reactive hydrogen may be used to react with the epoxide groups of the epoxy resin. Common classes of hardeners for epoxy resins include amines, acids, acid anhydrides, phenols, alcohols and thiols. These have a relative reactivity (lowest first) approximately in the order: phenol<anhydride<aromatic amine<cycloaliphatic amine<aliphatic amine<thiol.

While some epoxy resin/hardener combinations will cure at ambient temperature, some may require heat. Temperature is sometimes increased in a step-wise fashion to control the rate of curing and prevent excessive heat build-up from the exothermic reaction.

Hardeners which show only low or limited reactivity at ambient temperature, but which react with epoxy resins at elevated temperature are referred to as latent hardeners. When using latent hardeners, the epoxy resin and hardener may be mixed and stored for some time prior to use, which is advantageous for many industrial processes.

The epoxy curing reaction may also be accelerated by addition of small quantities of accelerators. Tertiary amines, carboxylic acids and alcohols (especially phenols) are effective accelerators.

The polyurethane dispersion of these embodiments of hybrid primer is a waterborne dispersion (or aqueous dispersion) of a polyurethane, preferably formed from one of an aliphatic diisocyanate or aromatic diisocyanate, one or more diols or polyols, a catalyst, and optionally, one or more additives selected from the group consisting of chain extenders and crosslinkers conventional in polyurethane chemistry.

In certain embodiments, the polyurethane dispersion comprises one or more hydroxyl and/or carboxyl functional groups reactive with one or both of the isocyanate containing compound and the epoxy resin, in order to permit formation of the crosslinked network of the hybrid primer of these embodiments.

The isocyanate containing compound used in these embodiments can be any isocyanate compound reactive with either, and preferably with both of the epoxy resin and polyurethane dispersion, and can be preferably a diisocyanate or polyisocyanate compound. Examples of such isocyanate containing compounds include, but are not limited to, aliphatic isocyanate containing compounds and aromatic isocyanate containing compounds, which may be blocked or unblocked isocyanates, with specific examples including, but not limited to, hexamethylene diisocyanate (HDI), isophorone diisocyanate (IPDI), 4,4′-diisocyanato dicyclohexylmethane (HMDI), and tetramethylxylylene diisocyanate (TMXDI), and blocked derivatives thereof.

Any suitable isocyanate blocking agent can be used if desired, including but not limited to, sodium bisulfite, diethyl malonate, 3,5-dimethylpyrazole, methylethyl ketone oxime (MEKO), phenol, or caprolactam.

These same isocyanate containing compounds, particularly the diisocyanate and polyisocyanate compounds can also be the isocyanate used in preparation of the polyurethane of the polyurethane dispersion.

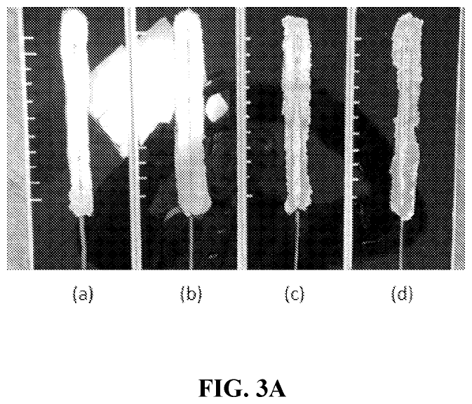

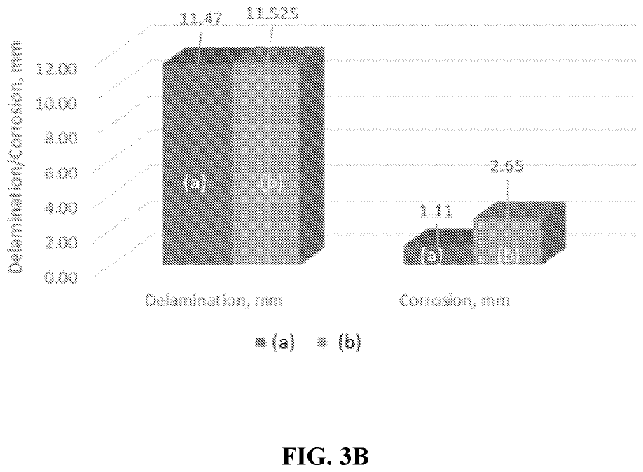

FIGS. 3A and 3B show the anti-corrosion performance of hybrid epoxy-polyurethane waterborne primers of embodiments of the present invention without the use of an etch primer compared with a conventional 2K polyurethane solvent borne control primer. The hybrid epoxy-polyurethane waterborne primer of embodiments of the present invention was sprayed on a cold rolled steel substrate without use of an etch primer, and the conventional 2K polyurethane solvent borne control primer was sprayed on a cold rolled steel substrate previously treated with an etch primer. To each of these was then placed a basecoat layer followed by a clearcoat layer.

Prior to salt spray chamber testing, the properties of the control and present invention primers on the cold rolled steel substrates were measured, along with measurement of the properties of each having the full set of layers (including basecoat and clearcoat). The results are shown in Table 1 below:

TABLE 1

| | | Hybrid Primer of Present |
|---|---|---|
| ID | Control | Invention |
| Chemical of primer | 2K solvent borne PU | Hybrid epoxy-polyurethane |

Primer on cold roller steel substrate

| | | |
|---|---|---|
| Cross-hatch | 5B | 5B |
| MEK rub (cycle) | >300 | >300 |

Full set panel

| Coating layer | Etch/Primer or hybrid primer/basecoat/clearcoat (mil) | |
|---|---|---|
| Thickness, mil | 0.24/6.36/0.4/3.52 | 0/3.76/0.4/3.52 |
| Impact (direct/indirect), psi | 150/160 | 160/160 |
| Conical mandrel bend | Pass | Pass |
| Dry adhesive (crosshatch) | 4% adhesive failure of | 2% cohesive failure of |
| | basecoat | hybrid primer |
| Gloss (20 degree) | 89.3 | 88.7 |
| DOI | 96.5 | 86.6 |

The thus coated substrates were tested in a salt spray chamber (in accordance with ASTM B117) for 20 days and the damaged areas of delamination and corrosion were examined. The results showed that both delamination and corrosion from the 2K polyurethane solvent borne control primer (a) (with etch primer) and the hybrid epoxy-polyurethane waterborne primer of embodiments of the present invention (b) (but without etch primer) were very close as shown in FIG. 3B.

A comparison of properties of the coated substrates using the hybrid epoxy-polyurethane waterborne primer of embodiments of the present invention without etch primer compared to those coated substrates using the conventional 2K polyurethane solvent borne control primer with etch primer were essentially the same, except that the substrates coated with embodiments of the hybrid epoxy-polyurethane waterborne primer without etch primer showed a slightly lower distinctness of image (DOI) (86.6) as compared to the substrates coated with the conventional 2K polyurethane solvent borne control primer using the etch primer (96.5). Due to the presence of hydroxy groups on the epoxy resin of the hybrid primer of embodiments of the present invention, the adhesive strength of the coating using the present invention hybrid primer is enhanced compared with the conventional polyurethane.

The performances of hybrid epoxy-polyurethane waterborne primers of the present invention were further evaluated by humidity chamber testing (GM14729). The results showed no significant difference in performance for the hybrid epoxy-polyurethane waterborne primers of the present invention compared to the conventional polyurethane.

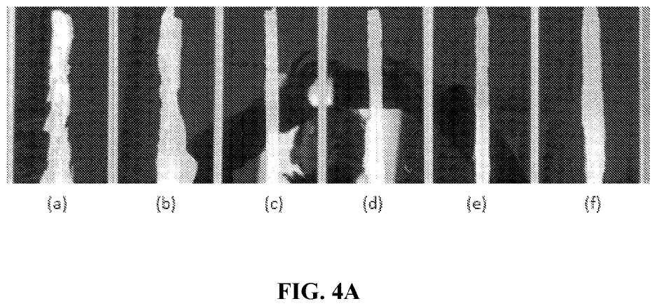

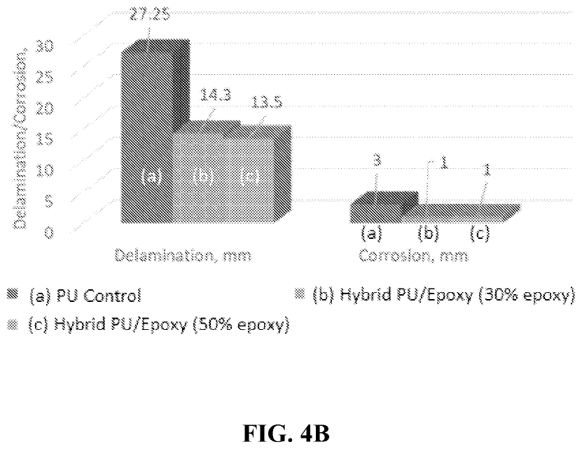

The hybrid epoxy-polyurethane waterborne primers of the present invention were further tested by using an etch primer (a solvent borne epoxy resin) coated on the cold rolled steel substrate first, followed by coating with the hybrid epoxy-polyurethane waterborne primers of embodiments of the present invention. The panels were then each coated with a basecoat, followed by a clearcoat. FIGS. 4A and 4B show the results of anticorrosion for the substrates coated with hybrid epoxy-polyurethane waterborne primer (at 30% epoxy content ((b) in FIG. 4B; (c) and (d) of FIG. 4A) and 50% epoxy content ((c) in FIG. 4B; (e) and (f) of FIG. 4A) by weight) with etch primer and those coated with the conventional 2K polyurethane solvent borne control primer ((a) in FIG. 4B; (a) and (b) of FIG. 4A) with etch primer, respectively. It is clear the anticorrosion property from hybrid epoxy-polyurethane using an etch primer is superior to that from the conventional polyurethane solvent borne control primer. The use of an etch primer significantly increases the adhesive strength of hybrid epoxy-polyurethane waterborne primers of the present invention. Since the hybrid primers of the present invention provide comparable adhesive property without the use of an etch primer, the introduction of an epoxy based etch primer increased adhesive strength between the hybrid primer of the present invention and the cold rolled steel substrate. Accordingly, anticorrosion property increased due to strong adhesion of the hybrid primers of the present invention on substrate.

The performance of substrates coated with the hybrid epoxy-polyurethane waterborne primers of embodiments of the present invention compared to those substrates coated with the conventional 2K polyurethane solvent borne control primer before and after humidity chamber testing were also tested. Poor adhesive strength was observed in the coated substrates having the conventional polyurethane control primer after humidity chamber testing at room temperature for one hour or 24 hours, while improved adhesive strength was achieved by the coated substrates having the hybrid epoxy-polyurethane waterborne primers of embodiments of the present invention, particularly when the amount of epoxy content was around 30% by weight in the hybrid waterborne primer. Accordingly, in embodiments of the present invention hybrid epoxy-polyurethane waterborne primer, the epoxy content is preferably from 20 to 40% by weight relative to total amount of primer, more preferably from 25 to 35% by weight relative to total amount of primer.

Enhancement of film durability was also evaluated by stone chip testing (GMW 14700). It was found that the hybrid epoxy-polyurethane waterborne primers of embodiments of the present invention provide improved durability when compared to a conventional 2K polyurethane solvent borne primer. Improved durability can be attributed to the rigid structure of epoxy resin.

A further comparison was performed between the conventional 2K polyurethane solvent borne primer control and embodiments of the present invention hybrid epoxy-polyurethane waterborne primers in which the NCO/OH equivalent ratio was increase to 1.5 and varying amounts of organic solvent (30%, 50% and 100%) were included in the composition. No significant change in properties was found for the embodiments of the present invention hybrid primers, except that chemical resistance decreased at higher levels of organic solvent in the hybrid primers. The hybrid primers using the organic solvent were found to have higher gloss and DOI properties compared to panels having lower NCO/OH equivalent ratios. While not wishing to be bound to any particular theory or mechanism of action, it is believed this improvement in gloss and DOI is due to the ability to create a denser crosslinking network, leading to the easier building of a smooth surface.

Normally, coatings will be degraded upon exposure to an environment of high humidity and temperature. Performance for the coated panels in anti-degradation using the hybrid primers of the present invention having higher equivalent weight ratios of NCO to OH were evaluated by exposure in a humidity chamber for 4 days. Optical appearance of the panels with respect to gloss 20 and DOI were similar to those from the conventional 2K polyurethane primer control. Some samples also showed better gloss 20 and DOI after the humidity test. While again not wishing to be bound to any particular theory or mechanism of action, it is believed that this can be attributed to a more stable structure generated by the hybrid primer of the present invention.

A measurement of adhesive loss of the coatings on the panels, measured before and after humidity chamber exposure, showed no significant difference in adhesive strength loss between the control primer and current invention hybrid primers.

The anti-corrosion performance of the various panels (conventional 2K polyurethane control primer, present invention hybrid primers with varying levels of organic solvent from 0 to 100%) was tested by salt fog chamber testing. No significant difference in size of corrosion was found between control and the embodiments of the present invention tested. However, it was found that the amount of delamination of the panels using the present invention hybrid primers increased with higher amounts of organic solvent present.

The measurements of various properties were carried out as follows:

Chemical resistance of primer—To check chemical resistance of a primer, panels coated with etch primer and primer are rubbed by one hammer covered with three layers of fiber paper soaked with MEK solvent. The specification of chemical resistance with MEK testing is more than 300 cycles without the surface being dissolved and steel surface being exposed, in accordance with ASTM D5402-19.

Adhesive strength—The adhesive strength of coating/film is evaluated by crosshatch testing in accordance with ASTM D3359. The failure mode of coating/film is also assessed based on observation of peeled coating/film on tape and substrate. This test rates the adhesion strength of the coating/film on each layer by removing pressure-sensitive tape stuck to the film cut by crosshatch.

Impact resistance—Impact resistance of coating/film coated on panels are assessed in accordance with ASTM D5420. The data is repeated twice, and both coated and non-coated sides are tested and recorded as direct and non-direct impact strength.

Conical Mandrel Bend—Flexible capability of coating/film is evaluated by Conical Mandrel Bend in accordance with ASTM D522.

Stone chip testing—Durability of film is measured in accordance with GM 14729.

Optical appearance—Optical appearance of coating/film is evaluated by Gloss Retention (20 Deg Gloss) and DOI Retention (Wavescan).

Humidity Chamber—Panels with edges are put into a humidity chamber at a temperature of about 30° C. for 4 days in accordance with GM 14729. The panels are dried with fiber paper after removal from the chamber and exposed at room temperature for 1 and 24 hours. The coating/film is then measured to determine Gloss (20 degree), DOI and cross-hatch.

Salt fog chamber—Panels with edges painted and having one line scratched in the middle are put in the salt fog chamber at a temperature of about 30° C. for 20 days in accordance with ASTM B117. The panels are washed with hot water and any loose coating/film removed with a metal spatula after removal from the chamber. The size of delamination and corrosion area are measured, and ten measured data points are averaged.

One embodiment for application of the hybrid primers of the present invention comprises spraying a solution of the hybrid epoxy-polyurethane waterborne primer of the present invention on a cold rolled steel substrate, with or without the application of an etch primer. After drying overnight at room temperature (23° C.) and normal humidity (~50%), the resulting coatings are sanded using 400# and 600# sandpaper, separately. Finally, an acrylate basecoat and a clearcoat are sprayed on the films separately and dried at room temperature.

The hybrid epoxy-polyurethane waterborne primer of some embodiments of the invention can be prepared by any desired method by which the epoxy resin and polyurethane dispersion become a crosslinked network, including, but not limited to: blending the epoxy resin, the polyurethane dispersion, and the isocyanate containing compound in an aqueous medium at a temperature and for a time sufficient to cause reaction between the epoxy resin, polyurethane dispersion and the isocyanate containing compound, to form the crosslinked network.

In one method of preparing the hybrid primers of the present invention, an epoxy waterborne primer, optionally including one or more solvents, additives, pigments, or corrosion inhibitors, is prepared by combining the optional components and mixing to fully disperse, such as, for example, by stirring with a dispersing disc for one hour, then the epoxy latex is added to the mixture, followed by cooling the resulting composition to room temperature. The polyurethane dispersion or latex is prepared by combining one or more optional solvents, additives, pigments and corrosion inhibitors as desired, and the resulting composition mixed, preferably by dispersing disc. After mixing, the polyurethane dispersion is added and the resulting mixture stirred and cooled.

The resulting epoxy waterborne primer and polyurethane dispersion are combined with the isocyanate containing compound, optionally with one or more pigments, solvents and additives and the resulting composition further stirred to permit reaction between the epoxy, polyurethane, and isocyanate containing compound to provide the crosslinked network of the hybrid primers of embodiments of the present invention.

While the embodiments discussed herein have been related to the hybrid waterborne primers and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several implementations, such feature may be combined with one or more other features of the other implementations as may be desired and advantageous for any given or particular application.

The following are non-limiting examples of some embodiments of the present invention:
Embodiment 1. A hybrid primer comprising a crosslinked polymer network formed from an epoxy resin, a polyurethane dispersion, and an isocyanate containing compound.
Embodiment 2. The hybrid primer of Embodiment 1, wherein the polyurethane dispersion comprises hydroxyl and carboxyl functional groups reactive with one or both of the isocyanate containing compound and the epoxy resin.
Embodiment 3. The hybrid primer of one of Embodiments 1 or 2, wherein the polyurethane dispersion comprises a polyurethane formed from one of an aliphatic diisocyanate or an aromatic diisocyanate, one or more diols or polyols, a catalyst, and, optionally, one or more additives selected from the group consisting of chain extenders and crosslinkers.
Embodiment 4. The hybrid primer of any one of Embodiments 1 to 3, wherein the epoxy resin is formed of units from epichlorohydrin and one or more bisphenol compounds.
Embodiment 5. The hybrid primer of Embodiment 4, wherein the one or more bisphenol compounds are selected from the group consisting of bisphenol A, bisphenol B, bisphenol E, bisphenol F, and bisphenol AF.
Embodiment 6. The hybrid primer of any one of Embodiments 1 to 5, wherein the isocyanate containing compound is an aliphatic isocyanate containing compound or an aromatic isocyanate containing compound, either of which may be blocked or unblocked.
Embodiment 7. The hybrid primer of any one of Embodiments 1 to 6, wherein the isocyanate containing compound is a water dispersible aromatic or aliphatic polyisocyanate.
Embodiment 8. The hybrid primer of any one of Embodiments 1 to 6, wherein the isocyanate containing compound is a member selected from the group consisting of hexamethylene diisocyanate (HDI), isophorone diisocyanate (IPDI), 4,4′-diisocyanato dicyclohexylmethane (HMDI), tetramethylxylylene diisocyanate (TMXDI), and blocked derivatives thereof.
Embodiment 9. A waterborne hybrid primer composition comprising the hybrid primer of any one of Embodiments 1 to 8 in an aqueous medium.
Embodiment 10. A method of preparing the hybrid primer of any one of Embodiments 1 to 8, comprising:
blending the epoxy resin, the polyurethane dispersion, and the isocyanate containing compound in an aqueous medium at a temperature and for a time sufficient to cause reaction between the epoxy resin, polyurethane dispersion and the isocyanate containing compound, to form the crosslinked network.

Additional modifications and variations of the present invention are possible in light of the above teachings. It is therefore to be understood that within the scope of the appended claims, the invention may be practiced otherwise than as specifically described herein.

What is claimed is:

1. A hybrid primer comprising a crosslinked polymer network formed from an epoxy resin, a polyurethane dispersion, and an isocyanate containing compound.

2. The hybrid primer of claim 1, wherein the polyurethane dispersion comprises hydroxyl and carboxyl functional groups reactive with one or both of the isocyanate containing compound and the epoxy resin.

3. The hybrid primer of claim 1, wherein the polyurethane dispersion comprises a polyurethane formed from one of an aliphatic diisocyanate or an aromatic diisocyanate, one or more diols or polyols, a catalyst, and, optionally, one or more additives selected from the group consisting of chain extenders and crosslinkers.

4. The hybrid primer of claim 1, wherein the epoxy resin is formed of units from epichlorohydrin and one or more bisphenol compounds.

5. The hybrid primer of claim 4, wherein the one or more bisphenol compounds are selected from the group consisting of bisphenol A, bisphenol B, bisphenol E, bisphenol F, and bisphenol AF.

6. The hybrid primer of claim 1, wherein the isocyanate containing compound is an aliphatic isocyanate containing compound or an aromatic isocyanate containing compound, either of which may be blocked or unblocked.

7. The hybrid primer of claim 1, wherein the isocyanate containing compound is a water dispersible aromatic or aliphatic polyisocyanate.

8. The hybrid primer of claim 1, wherein the isocyanate containing compound is a member selected from the group consisting of hexamethylene diisocyanate (HDI), isophorone diisocyanate (IPDI), 4,4′-diisocyanato dicyclohexylmethane (HMDI), tetramethylxylylene diisocyanate (TMXDI), and blocked derivatives thereof.

9. A waterborne hybrid primer composition comprising the hybrid primer of claim 1 in an aqueous medium.

10. A method of preparing the hybrid primer of claim 1, comprising:
blending the epoxy resin, the polyurethane dispersion, and the isocyanate containing compound in an aqueous medium at a temperature and for a time sufficient to cause reaction between the epoxy resin, polyurethane dispersion and the isocyanate containing compound, to form the crosslinked network.

11. The method of claim 10, wherein the polyurethane dispersion comprises hydroxyl and carboxyl functional groups reactive with one or both of the isocyanate containing compound and the epoxy resin.

12. The method of claim 10, wherein the polyurethane dispersion comprises a polyurethane formed from one of an aliphatic diisocyanate or an aromatic diisocyanate, one or more diols or polyols, a catalyst, and, optionally, one or more additives selected from the group consisting of chain extenders and crosslinkers.

13. The method of claim 10, wherein the epoxy resin is formed of units from epichlorohydrin and one or more bisphenol compounds.

14. The method of claim 13, wherein the one or more bisphenol compounds are selected from the group consisting of bisphenol A, bisphenol B, bisphenol E, bisphenol F, and bisphenol AF.

15. The method of claim 10, wherein the isocyanate containing compound is an aliphatic isocyanate containing compound or an aromatic isocyanate containing compound, either of which may be blocked or unblocked.

16. The method of claim 10, wherein the isocyanate containing compound is a water dispersible aromatic or aliphatic polyisocyanate.

17. The method of claim 10, wherein the isocyanate containing compound is a member selected from the group consisting of hexamethylene diisocyanate (HDI), isophorone diisocyanate (IPDI), 4,4′-diisocyanato dicyclohexylmethane (HMDI), tetramethylxylylene diisocyanate (TMXDI), and blocked derivatives thereof.
